(19) United States
(12) Patent Application Publication
(10) Pub. No.: US 2026/0074177 A1
(43) Pub. Date: Mar. 12, 2026

(54) DEVICE AND METHOD FOR MANUFACTURING ELECTRODE FOR SECONDARY BATTERY

(71) Applicant: SK On Co., Ltd., Seoul (KR)

(72) Inventors: Joo Won KANG, Daejeon (KR); Se Jin NAM, Daejeon (KR)

(21) Appl. No.: 19/312,312

(22) Filed: Aug. 28, 2025

(30) Foreign Application Priority Data
Sep. 6, 2024 (KR) 10-2024-0121354

(51) Int. Cl. H01M 4/04

(52) U.S. Cl. CPC H01M 4/0404

(57) ABSTRACT

A device and method for manufacturing an electrode for a secondary battery are provided. The device for manufacturing an electrode for a secondary battery includes a heating unit configured to heat an electrode current collector using an induction heating method, and a coating unit configured to apply electrode slurry to at least one surface of the electrode current collector heated by the heating unit.

### CROSS-REFERENCE TO RELATED APPLICATION(S)

This patent document claims the priority and benefits of Korean Patent Application No. 10-2024-0121354 filed on Sep. 6, 2024, the disclosure of which is incorporated herein by reference in its entirety.

### TECHNICAL FIELD

The disclosure and implementations disclosed in this patent document generally relate to a device and method for manufacturing an electrode for a secondary battery.

### BACKGROUND

Recently, active research has been conducted on electric vehicles (EVs) as a potential replacement for fossil fuel-powered vehicles, a major cause of air pollution. Lithium secondary batteries, with their high discharge voltage and output stability, are primarily used as the power source for such EVs.

The electrode manufacturing process for lithium secondary batteries involves a coating process and a drying process. In the coating process, an electrode slurry is applied to the surface of a current collector. The electrode slurry contains an active material, a binder, and a solvent. In the drying process, the electrode slurry applied to the current collector is dried and the solvent is evaporated. This process allows the active material to be fixed to the current collector surface via the binder, forming an electrode with an electrode active material layer.

Therefore, there is growing demand for the development of manufacturing devices and methods that may improve the performance and productivity of lithium secondary battery electrodes.

### SUMMARY

The present disclosure can be implemented in some embodiments to provide a device for manufacturing an electrode for a secondary battery, in which performance and productivity of an electrode for a secondary battery may be improved.

The present disclosure may be implemented in some embodiments to provide a method of manufacturing an electrode for a secondary battery, in which performance and productivity of an electrode for a secondary battery may be improved.

In some embodiments of the present disclosure, a device for manufacturing an electrode for a secondary battery includes a heating unit configured to heat an electrode current collector using an induction heating method; and a coating unit configured to apply electrode slurry to at least one surface of the electrode current collector heated by the heating unit.

In an embodiment, the heating unit may include an electrode current collector unwinder; and an induction heating device.

In an embodiment, the induction heating device may include a metal coil and an alternating current (AC) power supply.

In an embodiment, the device for manufacturing an electrode for a secondary battery may further include a drying unit drying a solvent in an electrode slurry applied on the electrode current collector in the coating unit.

In some embodiments of the present disclosure, a method of manufacturing an electrode for a secondary battery includes disposing an electrode collector roll on an unwinder and heating an electrode current collector by induction heating; and applying electrode slurry to at least one surface of the heated electrode current collector.

In an embodiment, the electrode collector roll may be formed by winding a metal foil around a foil core.

In an embodiment, a material of the foil core may be provided such that an induced current may be formed by an induction heating device.

In an embodiment, the foil core may be an alloy or ceramic containing at least one selected from the group consisting of iron (Fe), chromium (Cr), and carbon (C).

In an embodiment, the induction heating may be performed by an induction heating device including a metal coil and an AC power supply.

In an embodiment, the electrode current collector in the heating may be a cathode current collector, and the cathode current collector may be heated to 25° C. to 200° C.

In an embodiment, the electrode current collector of the heating may be an anode current collector, and the anode current collector may be heated to 25° C. to 200° C.

In an embodiment, the method of manufacturing an electrode for a secondary battery may further include drying a solvent included in the electrode slurry applied in the applying.

In an embodiment, the drying may be performed by at least one drying unit selected from the group consisting of hot air drying, infrared drying, and induction heating drying.

### BRIEF DESCRIPTION OF DRAWINGS

Certain aspects, features, and advantages of the present disclosure are illustrated by the following detailed description with reference to the accompanying drawings.

FIG. 1 schematically illustrates a device for manufacturing an electrode for a secondary battery according to an embodiment.

FIG. 2 schematically illustrates a device for manufacturing an electrode for a secondary battery according to another embodiment.

FIG. 3 provides SEM images illustrating cross-sections of electrodes for a secondary battery manufactured according to Example 1 and Comparative Example 1.

### DETAILED DESCRIPTION

Features of the present disclosure disclosed in this patent document are described by example embodiments with reference to the accompanying drawings.

Hereinafter, the technology disclosed in this specification and its implementation examples will be described in detail. However, the embodiments of the technology may be modified in various other forms, and the scope is not limited to the implementation examples described below. Furthermore, the technology disclosed in this specification may be applied not only by being limited to the configurations of the implementation examples described below, but also by selectively combining all or some of the implementation examples to enable various modifications.

### Device for Manufacturing Electrode

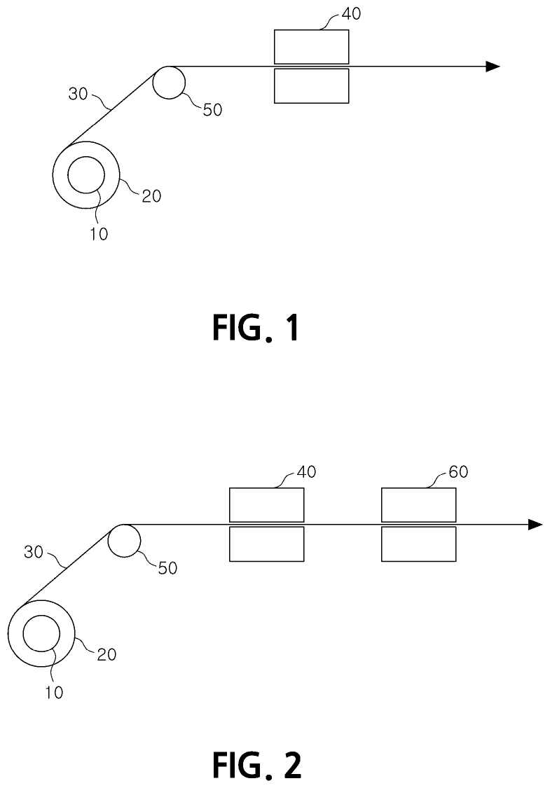

A device for manufacturing an electrode according to an embodiment may include a heating unit that heats an electrode current collector using induction heating and a coating unit applying electrode slurry to at least one surface of the electrode current collector heated by the heating unit. The device for manufacturing an electrode according to an embodiment includes a heating unit preheating the electrode current collector before applying the electrode slurry to the electrode current collector. Therefore, the electrode slurry is applied to the surface of the electrode current collector in the coating unit, and simultaneously therewith, the solvent within the electrode slurry is rapidly dried on the high-temperature surface of the electrode current collector, thereby reducing binder migration, a phenomenon in which a binder within the electrode slurry moves. Furthermore, by reducing binder migration, adhesive performance between the electrode current collector and the electrode slurry may be improved, thereby enhancing rapid charging characteristics of a secondary battery. Furthermore, as the drying time of the solvent within the electrode slurry is reduced through rapid drying, the manufacturing time of an electrode for a secondary battery may be shortened, thereby enhancing productivity. FIG. 1 schematically illustrates a device for manufacturing an electrode according to an embodiment. Hereinafter, a device for manufacturing an electrode according to an embodiment will be described in detail.

### Heating Unit

The heating unit may heat the electrode current collector using induction heating. In detail, the heating unit may include an electrode current collector unwinder and an induction heating device for disposing and unwinding an electrode collector roll prior to applying electrode slurry. The electrode collector roll refers to a metal foil used as an electrode current collector and wound around a foil core.

The unwinder may be cylindrical to facilitate disposition of the electrode collector roll. While the electrode current collector is heated by the induction heating device, the electrode collector roll remains disposed on the unwinder. Upon completion of heating, a separate roller rotates to unwind the metal foil used as the electrode current collector.

The induction heating device is provided to induction heat the electrode current collector by generating an induced current. Any device capable of generating an induced current is not particularly limited, and for example, may include a metal coil and an alternating current (AC) power supply connected to the metal coil. In detail, when AC power is supplied to the metal coil, an induced current is generated in the foil core and the metal foil from the metal coil, thereby induction heating the foil core and the metal foil. When the electrode current collector is induction heated by the induction heating device, the electrode current collector may be heated more quickly and power consumption may be reduced compared to heating the electrode current collector by heat conduction methods such as hot air, thereby being economical.

The induction heating device may be installed on the surface of or within the unwinder. Installing the induction heating device on or within the unwinder allows the existing unwinder to be utilized for unwinding the electrode current collector during the electrode manufacturing process, eliminating the need for a separate space for heating the electrode current collector, making it efficient.

Since the electrode current collector is preheated by induction heating in the heating unit, electrode slurry may be applied to the surface of the high-temperature electrode current collector in the coating unit described below. Therefore, rapid drying of the solvent within the electrode slurry may occur simultaneously with the application of the electrode slurry.

### Coating Unit

When the unwound electrode current collector heated in the heating unit reaches the coating unit, the coating unit may apply electrode slurry containing a prepared electrode active material, a binder, and other additives to at least one surface of the electrode current collector.

The coating unit is not particularly limited as long as it may apply electrode slurry to the surface of the electrode current collector, and for example, may include a coating device, such as a gravure coating device, a slot die coating device, a multilayer simultaneous die coating device, an imprinting device, a doctor blade coating device, a dip coating device, a bar coating device, a casting device, a spray coating device, or the like.

### Drying Unit

A device for manufacturing an electrode according to another embodiment may further include a drying unit for drying the solvent within the electrode slurry applied to the electrode current collector in the coating unit. FIG. 2 is a schematic diagram of the device for manufacturing an electrode of FIG. 1, further including a drying unit.

Since the electrode current collector is preheated in the heating unit, rapid drying of the electrode slurry begins from a lower layer portion simultaneously with the application of the electrode slurry to the current collector surface in the coating unit. In addition, as the electrode surface is dried using an additional heat source in the drying unit, an upper layer portion of the electrode slurry may also be rapidly dried. The drying unit is not particularly limited as long as it may dry the electrode surface using a heat source, and for example, may include at least one of a hot air drying device, an infrared drying device, or an induction heating drying device.

### Method of Manufacturing Electrode

A method of manufacturing an electrode according to another embodiment may include a heating operation of disposing an electrode collector roll on an unwinder, heating the electrode current collector using induction heating, and a coating operation of applying electrode slurry to at least one surface of the heated electrode current collector. The method of manufacturing an electrode according to an embodiment includes a heating operation of preheating the electrode current collector before applying the electrode slurry to the electrode current collector. Therefore, since the electrode slurry may be applied to the surface of the preheated, high-temperature electrode current collector, the solvent within both the upper layer portion and the lower layer portion of the electrode slurry may be rapidly dried. In this case, the upper layer portion of the electrode slurry refers to the electrode slurry formed close to the electrode surface, away from the surface of the electrode current collector, based on the thickness direction of the electrode, and the lower layer portion of the electrode slurry refers to the electrode slurry formed close to the surface of the electrode current collector.

Rapid drying of the solvent in the electrode slurry may reduce binder migration, a phenomenon in which a binder from the lower layer portion of the electrode slurry migrates to the upper layer portion of the electrode slurry. By reducing binder migration, the adhesion between the electrode current collector and the electrode slurry may be improved, thereby enhancing the rapid charging performance of secondary batteries. Furthermore, rapid drying may reduce drying time, thereby enhancing the productivity of electrodes for secondary batteries. Hereinafter, a method of manufacturing an electrode according to an embodiment will be described in detail.

### Heating Operation

A method of manufacturing an electrode according to an embodiment may include a heating operation of disposing an electrode collector roll on an unwinder and heating the electrode current collector using induction heating.

The electrode collector roll may be a metal foil, which is an electrode current collector, wound around a foil core. In the heating operation, the electrode collector roll may be heated while disposed on the unwinder. In the heating operation, the metal foil and foil core included in the electrode collector roll may be induction heated by the induction heating device.

The material of the foil core may be any material capable of generating an induced current by the induction heating device. In detail, the material is not particularly limited as long as it readily generates an induced current and may be rapidly heated. For example, the material may be ceramic or an alloy containing at least one selected from the group consisting of iron (Fe), chromium (Cr), and carbon (C). Therefore, the foil core may be rapidly heated to a higher temperature than the metal foil by induction heating, thereby transferring heat to the metal foil wound around the foil core. As a result, the metal foil used as the electrode current collector may be heated by receiving heat from the foil core heated to a high temperature.

The electrode current collector is not particularly limited as long as it may be used as an electrode current collector for a secondary battery. If the electrode current collector is a cathode current collector, stainless steel, nickel, aluminum, titanium, or alloys thereof may be included. The cathode current collector may include stainless steel or aluminum surface-treated with carbon, nickel, titanium, or silver. The thickness of the cathode current collector may be, but is not limited to, 10 to 50 μm, for example. If the electrode current collector is an anode current collector, copper foil, nickel foil, stainless steel foil, titanium foil, nickel foam, copper foam, a polymer substrate coated with a conductive metal, or the like may be included. The thickness of the anode current collector may be, but is not limited to, 10 to 50 μm, for example.

In the heating operation, the electrode current collector may be wound around the foil core and disposed on an unwinder in a roll form and heated. Therefore, in the case in which the electrode current collector is formed of a material capable of being heated by the induced current generated by an induction heating device, the electrode current collector may be directly inductively heated by the induction heating device. Furthermore, since the electrode current collector is wound around a foil core heated to a high temperature by induction heating, the electrode current collector may be heated by receiving heat from the high-temperature foil core. When the electrode current collector is mounted on the unwinder in a roll form and induction heated as described above, the electrode current collector may be directly inductively heated while simultaneously being heated by transferring heat from the foil core, thereby efficiently heating the electrode current collector.

In the heating operation, the induction heating may be performed by an induction heating device including a metal coil and an AC power supply, and the induction heating device may be installed on the surface of or within the unwinder. Installing the induction heating device on or within the unwinder eliminates the need for a separate space for heating the electrode current collector, making it efficient.

The electrode current collector in the heating operation may be a cathode current collector, and the cathode current collector may be heated to a temperature of 25 to 200° C., for example, 80 to 120° C. If the cathode current collector is heated to less than 25° C., the cathode current collector is not sufficiently heated, and thus, the solvent of the lower layer portion of cathode slurry applied to the surface of the cathode current collector does not dry well, resulting in a minimal improvement in the binder migration phenomenon and a longer total drying time. If the heating temperature of the cathode current collector exceeds 200° C., there is a problem in that the cathode current collector is damaged by oxidation due to excessive heating.

The electrode current collector in the heating operation may be an anode current collector, and the anode current collector may be heated to 25 to 200° C., for example, 80 to 120° C. If the anode current collector is heated to less than 25° C., the anode current collector is not sufficiently heated. Consequently, the solvent in the lower layer portion of the anode slurry applied to the surface of the anode current collector does not dry properly. This results in minimal improvement in binder migration and a longer total drying time. If the heating temperature of the anode current collector exceeds 200° C., the anode current collector may be oxidized and damaged by excessive heating.

When the electrode current collector is heated to a temperature within the above range, the electrode slurry is applied to the surface of the electrode current collector heated to a high temperature in the subsequent application operation. Therefore, the solvent in the lower layer portion of the electrode slurry may be rapidly dried simultaneously with the application of the electrode slurry. Consequently, the binder migration phenomenon of the electrode slurry may be reduced.

### Application Operation

After heating the electrode current collector in the heating operation, an electrode slurry containing an electrode active material, binder, and other additives prepared in the electrode coating unit may be applied to at least one surface of the electrode current collector.

The electrode slurry includes an electrode active material, a binder, and a solvent. Optionally, a conductive agent may be added. Furthermore, the viscosity may be adjusted to an appropriate level by adjusting the amount of solvent used or by using a thickener.

In detail, a cathode mixture slurry may be prepared by uniformly dispersing the cathode mixture in an organic solvent, such as N-methylpyrrolidone (NMP), and the prepared cathode mixture slurry may be applied to one surface or both surfaces of a cathode current collector of aluminum foil. In addition, an anode mixture slurry may be prepared by uniformly dispersing the anode mixture in an aqueous solvent, such as water, and the prepared anode mixture slurry may be applied to one or both surfaces of an anode current collector, such as copper foil.

The cathode mixture layer may include a cathode active material. The cathode active material may include a compound capable of reversibly intercalating and deintercalating lithium ions. According to example embodiments, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure or crystal structure represented by the following chemical formula 1.

LixNiaMbO2+z [Chemical Formula 1]

In Chemical Formula 1, 0.9≤x≤1.2, 0.6≤a≤0.99, 0.01≤b≤0.4, and −0.5≤z≤0.1. As described above, M may include Co, Mn, and/or Al.

The chemical structure represented by Chemical Formula 1 represents the bonding relationships within the layered or crystal structure of the cathode active material and does not exclude other additional elements. For example, M includes Co and/or Mn, and Co and/or Mn, along with Ni, may serve as the main active element of the cathode active material. Chemical Formula 1 is provided to express the bonding relationships of the main active elements and should be understood as encompassing the introduction and substitution of additional elements.

The binder included in the cathode mixture layer may include polyvinylidene fluoride (PVDF), poly(vinylidene fluoride-co-hexafluoropropylene copolymer, polyacrylonitrile, polymethylmethacrylate, acrylonitrile butadiene rubber (NBR), polybutadiene rubber (BR), styrene-butadiene rubber (SBR), or the like. In an embodiment, a PVDF-based binder may be used as the cathode binder.

The anode mixture layer may include an anode active material. A material capable of adsorbing and desorbing lithium ions may be used as the anode active material. For example, the anode active material may be a carbon-based material such as crystalline carbon, amorphous carbon, carbon composite, or carbon fiber; lithium metal; lithium alloy; silicon (Si)-containing material, tin (Sn)-containing material, or the like.

Examples of the amorphous carbon may include hard carbon, soft carbon, coke, mesocarbon microbeads (MCMB), mesophase pitch-based carbon fiber (MPCF), and the like.

Examples of the crystalline carbon may include graphitic carbons such as natural graphite, artificial graphite, graphitized coke, graphitized MCMB, and graphitized MPCF.

The lithium metal may be pure lithium metal or lithium metal with a protective layer formed thereon to suppress dendrite growth or the like. In an embodiment, a lithium metal-containing layer deposited or coated on an anode current collector may be used as the anode active material layer. In an embodiment, a lithium thin film layer may be used as the anode active material layer.

Elements included in the lithium alloy may include aluminum, zinc, bismuth, cadmium, antimony, silicon, lead, tin, gallium, indium, or the like.

The silicon-containing material may provide increased capacity characteristics. The silicon-containing material may include Si, SiOx(0<x<2), metal-doped SiOx(0<x<2), silicon-carbon composites, or the like. The metal may include lithium and/or magnesium, and the metal-doped SiOx(0<x<2) may include metal silicates.

The binder included in the anode mixture layer may include a styrene-butadiene rubber (SBR)-based binder, carboxymethyl cellulose (CMC), a polyacrylic acid-based binder, a poly(3,4-ethylenedioxythiophene, PEDOT)-based binder, or the like.

The electrode slurry may be applied to the surface of the electrode current collector using, but is not particularly limited to, gravure coating, slot die coating, multilayer simultaneous die coating, imprinting, doctor blade coating, dip coating, bar coating, casting, spray coating, or other methods.

### Drying Operation

A method of manufacturing an electrode according to another embodiment may further include a drying operation of drying the solvent contained in the electrode slurry applied onto the electrode current collector in the coating unit.

The drying operation is not particularly limited as long as it may dry the solvent within the electrode slurry using a separate heat source, and for example, may be performed using at least one drying method selected from the group consisting of hot air drying, infrared drying, and induction heating drying.

In detail, in the drying operation, hot air is supplied to the electrode surface on which the electrode slurry is applied on the electrode current collector to heat and evaporate the solvent within the electrode slurry. When supplying hot air to the drying furnace in the drying operation, the temperature and air volume of the hot air may be controlled. Although not particularly limited, the hot air may be applied to the electrode surface through a slotted or perforated nozzle.

The hot air applied to the electrode surface on which the electrode slurry is applied evaporates and removes the solvent within the electrode slurry. The binder secures the electrode active material to the surface of the electrode current collector, allowing for bonding between the electrode active materials.

In the present disclosure, when drying of the solvent in the electrode slurry occurs in the drying operation, the electrode current collector is preheated in the heating operation, enabling rapid drying of the solvent not only on the electrode surface but also in the lower layer portion of the electrode slurry. Therefore, binder migration within the electrode slurry may be effectively alleviated, thereby improving the adhesion between the electrode current collector and the electrode slurry and enhancing the rapid charging performance of secondary batteries. Furthermore, rapid drying reduces the manufacturing period of time for electrodes for secondary batteries, thereby improving productivity.

### EXAMPLES

Hereinafter, embodiments will be further described with reference to detailed experimental examples. The examples and comparative examples included in the experimental examples are intended to illustrate the present disclosure and not to limit the scope of the appended claims. It will be apparent to those skilled in the art that various modifications and variations of the examples are possible within the scope and spirit of the present disclosure, and it is understood that such modifications and variations fall within the scope of the appended claims.

### Example 1

An anode slurry was prepared by mixing 97.5 wt % of an anode active material in which natural graphite and artificial graphite are mixed in a 3:7 weight ratio, with 100 wt % of a solid mixture of 1.5 wt % of a graphite-based conductive agent, 0.6 wt % of carboxymethyl cellulose and 0.4 wt % of styrene-butadiene rubber, and with 100 wt % of pure water as a solvent.

The anode collector roll in which copper foil is wound around a stainless steel foil core, was mounted on a cylindrical unwinder equipped with an induction heating device, including a metal coil and an AC power supply.

Thereafter, AC power was supplied to the coil, inducing an induced current in the anode collector roll. Accordingly, the anode current collector was heated to 100° C. for 10 minutes using induction heating.

After unwinding the heated anode current collector, the prepared anode slurry was uniformly applied at 11 mg/cm² to both surfaces of an 8 μm-thick copper foil.

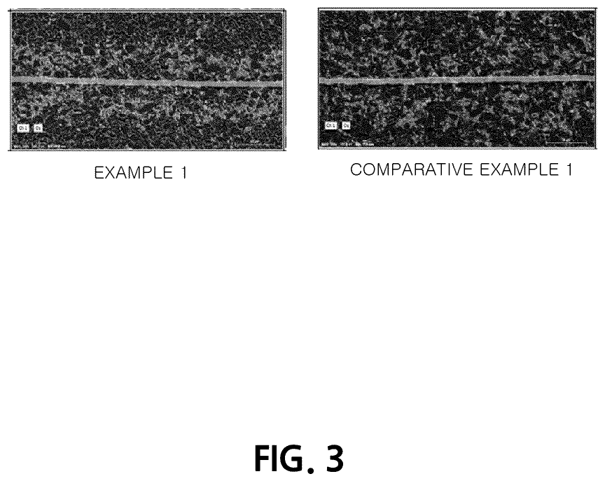

Then, the anode was manufactured by performing drying in a drying oven equipped with a hot air nozzle. A cross-sectional SEM image of the prepared anode is illustrated in FIG. 3.

### Comparative Example 1

An anode was prepared using the same method as in Example 1, except that the anode current collector was not heated by induction heating. A cross-sectional SEM image of the prepared anode is illustrated in FIG. 3.

Referring to FIG. 3, in Example 1, where the current collector was preheated by induction heating before applying the electrode slurry to the electrode current collector, binder agglomeration occurred near the current collector as compared to Comparative Example 1. This may be attributed to the preheating of the electrode current collector, which allowed the electrode slurry to be applied to the surface of the electrode current collector and simultaneously allowed the lower layer portion of the electrode slurry to dry rapidly, thereby reducing binder migration.

As a result, it can be seen that the adhesion between the current collector surface and the electrode slurry increases as the binder migration phenomenon decreases, and the rapid charging characteristics may be improved due to the reduction in binder on the electrode surface. Therefore, it can be confirmed that the performance of electrodes for secondary batteries may be improved, and the drying time may be shortened, thereby enhancing productivity.

As set forth above, according to an embodiment, a device for manufacturing an electrode for a secondary battery, in which performance and productivity of an electrode for a secondary battery may be improved, may be provided.

According to another embodiment, the performance and productivity of an electrode for a secondary battery may be improved.

Only specific examples of implementations of certain embodiments are described. Variations, improvements and enhancements of the disclosed embodiments and other embodiments may be made based on the disclosure of this patent document.

What is claimed is:

1. A device for manufacturing an electrode for a secondary battery, comprising:
a heating unit configured to heat an electrode current collector using an induction heating method; and
a coating unit configured to apply electrode slurry to at least one surface of the electrode current collector heated by the heating unit.

2. The device of claim 1, wherein the heating unit includes,
an electrode current collector unwinder; and
an induction heating device.

3. The device of claim 2, wherein the induction heating device includes a metal coil and an alternating current (AC) power supply.

4. The device of claim 1, further comprising a drying unit drying a solvent in an electrode slurry applied on the electrode current collector in the coating unit.

5. A method of manufacturing an electrode for a secondary battery, comprising:
disposing an electrode collector roll on an unwinder and heating an electrode current collector by induction heating; and
applying electrode slurry to at least one surface of the heated electrode current collector.

6. The method of claim 5, wherein the electrode collector roll is formed by winding a metal foil around a foil core.

7. The method of claim 6, wherein a material of the foil core is provided such that an induced current is capable of being generated by an induction heating device.

8. The method of claim 6, wherein the foil core is an alloy or ceramic containing at least one selected from the group consisting of iron (Fe), chromium (Cr), and carbon (C).

9. The method of claim 5, wherein the induction heating is performed by an induction heating device including a metal coil and an AC power supply.

10. The method of claim 5, wherein the electrode current collector in the heating is a cathode current collector, and the cathode current collector is heated to 25° C. to 200° C.

11. The method of claim 5, wherein the electrode current collector of the heating is an anode current collector, and the anode current collector is heated to 25° C. to 200° C.

12. The method of claim 5, further comprising drying a solvent included in the electrode slurry applied in the applying.

13. The method of claim 12, wherein the drying is performed by at least one drying unit selected from the group consisting of hot air drying, infrared drying, and induction heating drying.
